(19) United States
(12) Patent Application Publication
(10) Pub. No.: US 2006/0236839 A1
(43) Pub. Date: Oct. 26, 2006

(54) Drive belt cutter assembly

(76) Inventors: Bradford J. Munch, JASPER, IN (US); John M. Segal, Jasper, IN (US)

Correspondence Address: Barnes & Thornburg, 11 South Meridian Street, Indianapolis, IN, 46204, US

(21) Appl. No.: 10/551,983

(22) PCT Filed: May 26, 2004
(86) PCT No.: PCT/US04/16600

§ 371 Date: Oct. 4, 2005

Related U.S. Application Data
(60) Provisional application No. 60/473,594, filed on May 27, 2003.

(51) Int. Cl. B26D 3/06

(52) U.S. Cl. 83/875

(57) ABSTRACT

A plurality of cutter tools are arranged to provide a cutter assembly, each cutter tool being configured to hold replaceable cutter blades. The cutter blades cooperate to cut a groove in a rubber material.

### CROSS-REFERENCE TO RELATED APPLICATIONS

This application claims priority under 35 U.S.C. 119(e) to U.S. Provisional Application Ser. No. 60/473,594, filed May 27, 2003, which is expressly incorporated by reference herein.

### BACKGROUND OF THE INVENTION

Drive belts are provided with grooved surfaces which engage driving and driven members such as pulleys. These drive belts are typically formed in a piece of rubber or a flexible substrate material. The grooved surfaces of the substrates material are advanced through rotary cutters which form the grooves.

### SUMMARY OF THE INVENTION

The present invention comprises one or more of the following features or features identified in the various independent claims and dependent claims appended to this application and combinations of such features.

Either individual cutting tools or, a plurality of cutting tools for cutting drive belts is provided and rotated about the axis of the arbor to cut grooves in the rubber substrate from which belts are formed. Each tool comprises a tool body having a central bore for receiving the arbor, axially spaced apart, radially extending opposite side faces, and an outer peripheral portion. A plurality of sets of cutting blades are removably coupled or mounted about the peripheral portion of each tool body. For example, a tool body which is approximately six to twelve inches {about 15 to 31 cm) in diameter may have four sets of three cutter blades per set peripherally spaced about each tool body. Each blade set will typically include a left-hand cutter blade, a right-hand cutter blade and a raker blade. These designations left-hand and right-hand are used herein for convenience in distinguishing the blades. The left-hand and right-hand blades have cutting edges provided with outwardly extending teeth which form the grooves in the drive belt surface. The raker blade, which typically follows the left-hand and right-hand cutter blades, cuts the flats between the grooves. The left-hand cutter blades have teeth which cut the left-hand edges of the grooves and the right-hand cutter blades have teeth which cut the right-hand edges of the grooves.

In some embodiments, for some applications, each blade set will typically include a left-hand cutter blade and a right-hand cutter blade. In such an embodiment, the raker blade may not be used and the left and right-hand cutter blades may be configured to cut the O.D. flat of the belt surface between the v-grooves. In such an embodiment, each cutting tooth on each of the left-hand blade and right-hand blade may be configured to cut at least a portion of the O.D. flat adjacent a v-groove cut by the tooth and, in some embodiments, each tooth will be configured to cut the entire O.D. flat between the v-groove cut by the tooth and the next adjacent v-groove.

Thus, in some embodiments, each of the left-hand and right-hand blades will serve to cut the left or right side of adjacent v-groove and, at the same time, without a separate raker blade, cut the O.D. flat between adjacent grooves.

The cutter blades are removably coupled to the outer peripheral portions of the tool bodies. The cutter blades, which may be removed and replaced as they wear out, may illustratively be accurately positioned in slots or cavities formed in the outer peripheral portion of each tool body. Each cutter blade is provided with three mounting points or locating protuberances which position the blade in its position on the tool body with its cutting edge extending radially outwardly from the outer peripheral portion of the tool body and its base portion or support portion extending radially inwardly of the outer peripheral portion. Each cutter blade may illustratively be positioned and held by combinations of screws and wedges which position and secure the blade in the tool body. Illustratively, each cutter blade will be carefully positioned on its tool body relative to the other cutter blades on the tool body and relative to similar cutter blades on adjacent tool bodies. Illustratively, each tool body may be provided with one or more recesses associated with each set of cutter blades on at least one of its side faces. Then, illustratively, each tool body may be provided with one or more axially extending protuberances associated with each set of cutter blades on one of its side faces. Such protuberances engage into such recesses to position adjacent tool bodies to align and orient the cutter blades on the tool bodies.

The present invention comprises removable blades, each of which has novel and unique features as discussed above. It is contemplated that such blades will be provided to end users as replacement blades as they wear out. Each blade is illustratively a generally flat blade having a base edge, a cutting edge, and two side edges. Each blade has a forwardly facing surface (forwardly in the direction of rotation of the tool body) and an opposite rearwardly facing surface. Each blade may illustratively have one or more holes through its body into which projections from a fastening wedge may extend to hold the blade in the tool body. Each blade may illustratively be provided with three mounting points or protuberances which will locate the blade relative to the tool body. Illustratively, two of these mounting points or locating protuberances may be on the base edge of the blade and one of the points or protuberances may be on a side edge of the blade. As indicated above, the blades will be provided in sets of three blades with one blade being a left-hand blade, one blade being a right-hand blade, and a third blade being a raker blade. The left-hand blade and the right-hand blade will have a plurality of pointed teeth extending outwardly from the cutting edge to form grooves as indicated above. In other embodiments, as indicated above, the blades will be provided in sets of two blades with one blade being a left-hand blade, and one blade being the right-hand blade and both blades configured to cut the belt O.D. flat between the adjacent grooves.

The left-hand blades and the right-hand blades are mountable on the tool body such that each left-hand blade and each right-hand blade defines a shear angle relative to a plane which includes the axis of the tool body and extends radially outwardly from the axis. Similarly, the raker blade is mountable on the tool body to define a shear angle relative to the plane defined above. The shear angle is in the range of 10-20 degrees. The raker blade also has a positive hook in the range of 10-30 degrees. As illustrated, the left-hand and right-hand blades have a zero degree hook.

In an embodiment where the raker function is incorporated in the left-hand and right-hand cutter blades, such cutter blades may have a hook angle in the range of 10-30 degrees.

### BRIEF DESCRIPTION OF THE DRAWINGS

The detailed description particularly refers to the accompanying figures in which:

FIG. 1A is a side view of an end cutter tool;

FIG. 1B is side view of a cutter tool;

FIG. 1C is a roll-out view of a single cutter tool of FIGS. 1A-B, showing the alignment of the cutter blades as if the cutter tool was rolled out;

FIG. 1D is a roll-out view of another cutter tool similar to that of FIG. 1C, showing the alignment of the cutter blades as if the cutter tool was rolled out;

FIG. 1E is an elevation view of a plurality of cutter tools and one end cutter tool of FIGS. 1A-B, showing the groove arrangement that would be left by the cutter blades on a substrate that is subjected to the cutter blades;

FIG. 2A is an elevation view of a cutting edge of a left-hand cutter blade;

FIG. 2B is an elevation view of a cutting edge of a right-hand cutter blade;

FIG. 2C is an elevation view of a cutting edge of an alternative cutter blade;

FIG. 2D shows a side view of one embodiment of a cutter blade having a tapered trailing surface;

FIG. 2E shows a side view of another embodiment of a cutter blade having a tapered trailing surface;

FIG. 2F is a perspective view of a plurality of cutter tools and one end tool in coaxial alignment;

FIGS. 3A-E are views of various cutter blades;

FIGS. 3F-K are views of various wedges used to engage the cutter blades;

FIG. 3L is a side view of a cutter tool;

FIG. 3M is a side view of a cutter tool;

FIG. 4A is an elevation view of an attack face of a right-hand cutter blade;

FIG. 4B is an elevation view of a trailing face of the right-hand cutter blade of FIG. 4A;

FIG. 4C is an elevation view of an attack face of a left-hand cutter blade;

FIG. 4D is an elevation view of a trailing face of the left-hand cutter blade of FIG. 4C;

FIG. 5 is an elevation view of a portion of an alternative embodiment for a cutter tool;

FIG. 6 shows a cross-sectional view of the groove that is formed with the combination of the left-hand and right-hand cutter blades;

FIG. 7 shows a cross-sectional view of a left-hand and right-hand cutter blade as they form grooves in the substrate;

FIG. 8A shows a raker blade which is to be placed in the same cavity as its associated cutter blade having teeth;

FIG. 8B shows a cutter blade with teeth for use with the raker blade of FIG. 8A;

FIG. 8C shows the cavity in which the blades of 8A and 8B are to be inserted; and

FIG. 8D shows how the raker blade of FIG. 8A and cutter blade of FIG. 8B are held in the cavity shown in FIG. 8C by a mounting screw and wedge arrangement shows in FIGS. 3F-M except modified to have protrusions of the wedge through both the adjacent raker and cutter blades.

### DETAILED DESCRIPTION OF THE DRAWINGS

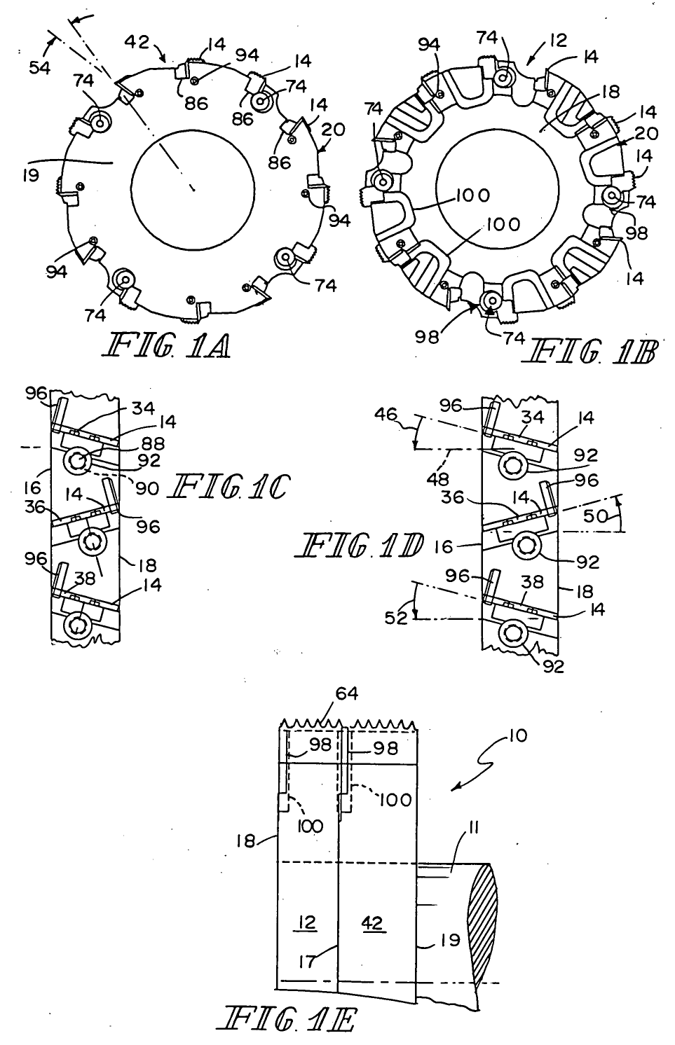

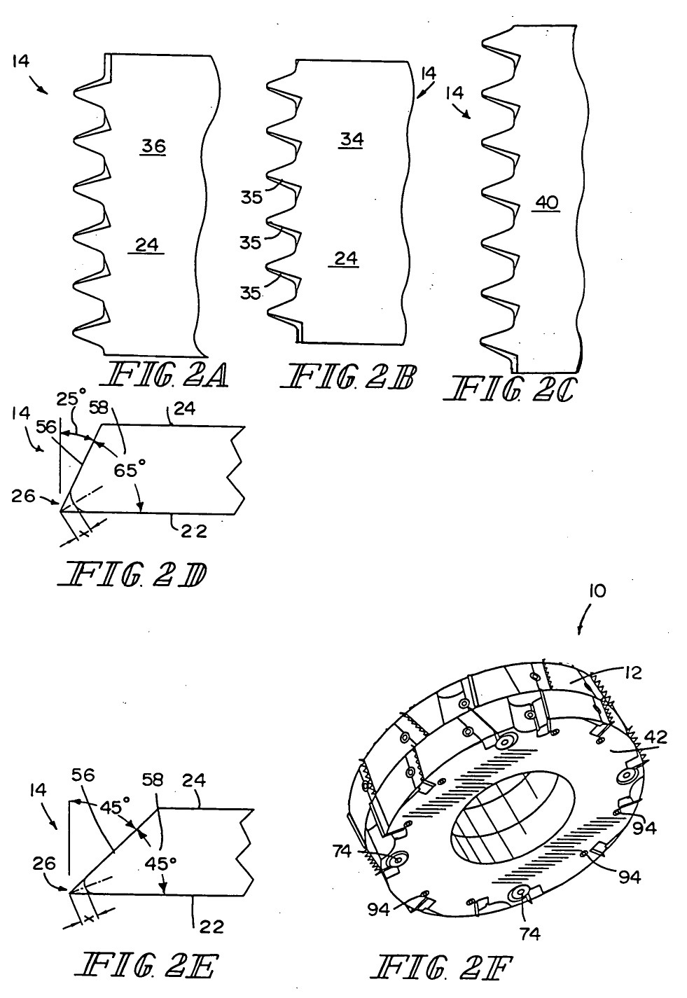

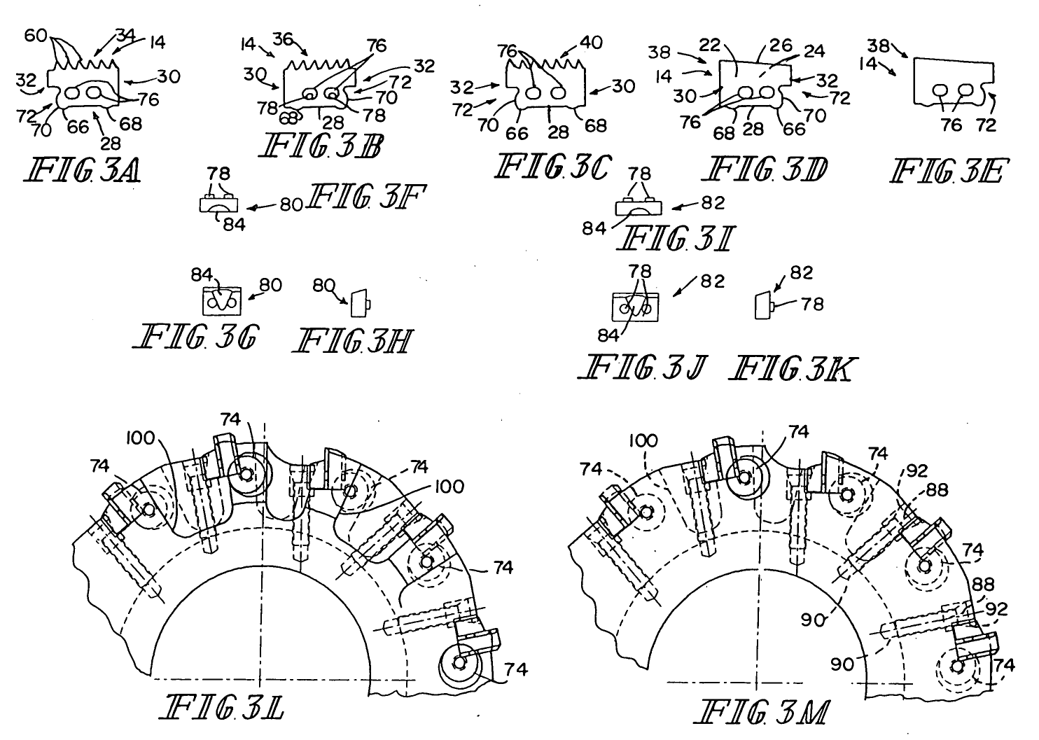

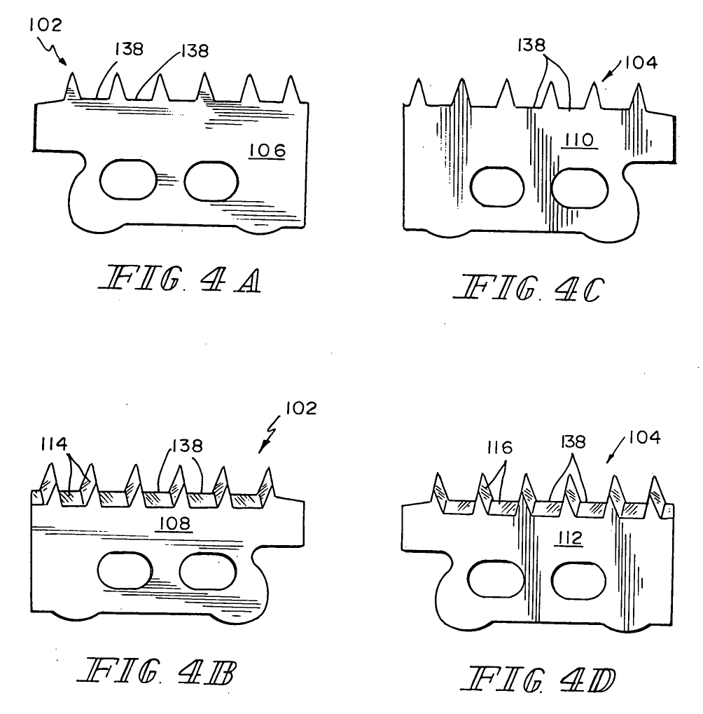

As can be seen in FIGS. 1E and 2F, a cutter assembly 10 illustratively comprises a plurality of cutter tools 12 formed to be axially aligned on an arbor 11. Cutter tools 12, while mounted on arbor 11, rotate and present cutter blades 14 to a substrate to be cut or formed, the substrate illustratively being a flexible composite profiled material belt for use in driving components associated with an engine or motor (not shown).

Cutter tools 12 each have axially spaced apart, radially extending side faces 16, 18, as can be seen in FIGS. 1C-D. Each cutter tool also has an outer peripheral portion 20 configured to receive and hold a plurality of replaceable blades 14 peripherally spaced about the peripheral portion 20, as can be seen in FIGS. 1A-D. As can be seen in FIGS. 3A-E, blades 14 are generally flat and have a front side 22, a back side 24 (seen in FIGS. 2D and 2E), a cutting edge 26 to extend outwardly from the tool body 12, a base edge 28 opposite to the cutting edge 26 to extend into the tool body 12, and opposite first and second side edges 30, 32 between cutting edge 26 and base edge 28. The blades are illustratively oriented on the cutter tools 12 in sets of three in order to cut V-shaped grooves and flat surfaces on a drive belt. A left-hand cutter blade 36 is provided for cutting a left side of a V-shaped groove, a right-hand cutter blade 34 is provided for cutting a right side of the V-shaped groove, and a raker blade 38 is provided for creating a flat surface on the peaks of the grooves on the drive belt. An alternate cutter blade 40 can be used on an end tool 42, described further herein. As can be seen in FIGS. 2C and 3C, alternate cutter blade 40 has an additional low-profile tooth 44 in order to provide the final groove in the drive belt, the final groove signifying where the drive belt should be cut away from the excess substrate material.

Cutter tools 12 and their associated cutter blades 34, 36, 38 (collectively blades 14) are illustratively formed and arranged in the following fashion. Right-hand cutter blades 34 are given a shear angle (as indicated by reference number 46 in FIG. 1D) relative to a tool body axial line 48 (such a line falls in a plane which includes the axis of the tool body and extends radially outwardly from the axis) such that the right-hand cutter blades 34 are presented to the drive belt substrate material at an approximate 15-degree angle. Left-hand cutter blades 36 are angled by an angle 50 such that each is presented to the drive belt substrate in an opposite approximate 15-degree angle. Raker blades 38 are also oriented at an angle 52 (again, illustratively a 15-degree angle) relative to an axial line in order to minimize cutting pressure. Although the illustrative angle is 15 degrees, a shear angle range between 10 and 20 degrees is possible. However, it should be understood that although specific angles and ranges are provided herein, other angles and ranges are within the scope of the disclosure and the claims are not intended to be limited to these exemplary ranges and angles.

Raker blades 38 also illustratively have a ‘hook’ angle—an angle at which the blade is placed in order to achieve an attack angle. Illustratively, raker blades 38 are mounted to have a positive 15 degree hook angle 54 on the lead side edge, as can be seen in FIGS. 1A-B. (Due to the shear of raker blade 38, the trailing side edge of raker blades 38 may have an approximate 20 degree hook angle.) The hook angle may range between 10-30 degrees, however. The positive hook angle creates an angle of attack for the cutting edge of raker blades 38.

Illustratively, as can be seen in FIG. 3D, cutting edge 26 of raker blade 38 is inclined to accommodate the hook and orientation of the raker blade 38 on the cutter tool 12.

An illustrative tooth or blade is shown in each of FIGS. 2D and 2E, the blade having a front side 22, a back side 24, and a cutting edge 26. Cutting edge 26 illustratively has a tapered trailing surface 56 having an angle 58, which allows for a sharp cutting edge 26 and minimizes the heat created during the cutting process. By having a tapered trailing surface 56, the elastomeric substrate material is not exposed to as much friction from rubbing on blade 14 during the cutting process, and consequently heat is reduced. However, it is also important to have sufficient strength in cutting edge 26, therefore angle 58 is ideally large enough to achieve the requisite strength needed for continued use of cutting edge 26. Regardless of the angle 58 used, however, some wear and tear is anticipated on cutting edge 26, such wear eventually leading to a more dull cutting edge 26 that is also worn by a distance X, as can be illustratively seen in FIGS. 2D-E. Eventually, such a cutter blade 14 will need to be replaced.

However, during the wear process, it has been determined that not only is friction reduced, the cutting edge 26 is also kept sharper when a smaller angle 58 (such as shown in FIG. 2E) is used on cutting edge 26. When cutting rubber and similar elastomeric substrate materials, a sharp cutting edge can minimize heat, and thereby prevent unwanted results such as melted vinyl or synthetic rubber. It has been determined that an angle 58 (referred to in the art as the “included tip angle”) that falls within the range of 35-45 degrees gives an optimal balance of cutting edge strength, minimal friction, and cutting edge longevity. An angle of 40 degrees has been used successfully in the manufactured embodiment.

An illustrative elevation view of cutter blades 14 is shown in FIGS. 3A-E. As can be seen, each tooth-bearing cutter blade 34, 36 includes a plurality of high-profile teeth 60. The high-profile teeth are configured to cut either a right-side or a left-side of a V-shaped groove. As can be seen in FIG. 1E, the cutter blades 34, 36 are aligned such that a drive belt pattern 64 is cut on the rubber drive belt material.

Illustratively, cutter blades 14 each also have three locating protuberances, of which two locating protuberances 66, 68 are located on the base edge 28 of the cutter blade 14 and one locating protuberance 70 is located on a side edge 32 of the cutter blade 14, as can be seen in FIG. 3A. The locating protuberance 70 is illustratively formed in notch 72, however, it should be understood that other positions for locating protuberance 70 are within the scope of the disclosure. Notch 72 is formed in each cutter blade 14 in order to receive the head of positioning screw 74. Cutter blades 14 further illustratively include two retainer holes 76 that mate with projections 78, which extend from wedges 80, 82. Wedge 80 is illustratively sized for cooperation with cutter tool 12, and wedge 82 is illustratively sized for cooperation with end tool 42. Wedges 80, 82 and their method of mounting is described further below.

Each tooth is illustratively formed to have a right side angle 37 or a left side angle 35. In the right-hand cutter blade 34 shown in FIG. 2B, the left side angles (as viewed from the back of the blade) 35 are formed to have a 30 degree tapered surface (relative to the side 30 of the blade). Therefore, when right-hand cutter blade 34 is mounted with the above-described 15 degree shear, the cutter blade forms a lead cutting edge with trailing surfaces of 15 degree angles on each side. Similarly, left-hand cutter blade, shown in FIG. 2A, has right side angles (as viewed from the back of the blade) 37 with a 30 degree tapered surface (relative to the side 30 of the blade). Such a configuration allows left-hand cutter blade 36 to be mounted with a 15 degree shear, thereby forming two trailing surfaces with 15 degree effective side clearance on each side.

Illustratively, cutter blades 14 are mounted on cutter tools 12 in the following fashion. A cutter blade 14 is positioned adjacent a wedge 80 (or alternative cutter blade 40 is positioned adjacent wedge 82) such that protrusions 78 extend through retainer holes 76 (visible in FIG. 3B). Illustratively, protrusions 78 function as an additional safety measure to retain blades 14, 40 on cutter tool 12 during use. Cutter blades 14, 40 and their associated wedges 80, 82 are then positioned in the appropriate blade channel 86, visible in FIGS. 1A-D. A wedge retainer screw 88 is threaded in its respective threaded hole 90 (visible in FIG. 3M) to engage indention 84 formed in each wedge 80, 82. Screw head 92 (visible in dashed lines in FIG. 3M) and indention 84 are illustratively correspondingly sloped such that as wedge retainer screw 88 is further threaded into threaded hole 90, screw head 92 causes wedge 80 or 82 to further secure blade 14 or 40 in channel 86. Blade 14 or 40 is properly secured and in radial alignment in channel 86 when locating protuberances 66, 68 on base edge 28 of cutter blade 14 or 40 contact the bottom surface of channel 86.

The axial alignment of cutter blades 14, 40 is illustratively achieved in the following fashion. After cutter blade 14 or 40 is in its respective blade channel 86, a positioning screw 74 is threaded into a threaded hole on one of side faces 16, 18 of cutter tool 12 until the head 96 of positioning screw 74 abuts locating protuberance 70 of blade 14 or 40. Cutter blade 14 or 40 is then positioned axially as required to align the cutting teeth in the desired track to profile the flexible composite material as desired. A set screw 94 is then threaded into an opposite face 16, 18 of cutter tool 12 until it abuts positioning screw 74, thereby setting the “stop” position of positioning screw 74.

Illustratively, cutter tools 12 can be coaxially aligned on a shaft or arbor 11 and positioned such that they axially abut each other to form a single rotating cutter assembly 10, as can be seen in FIGS. 1E and 2F. Illustratively, cutter tools 12 are formed such that they can interlock with each other, the interlock being formed in the following fashion. Each cutter tool 12 has two side faces 16, 18. End tool 42 also has two side faces 17, 19, as can be seen in FIGS. 1A and 1B. Each side face 16, 17, 18 (but not side face 19 of end tool 42) illustratively has either protuberances 98, recesses 100, or both formed therein. When cutter tools 12 are aligned in a gang such as that seen in FIGS. 1E and 2F, such protuberances 98 align with recesses 100 of an adjoining cutter tool 12, thereby interlocking the two cutter tools 12. Such alignment is illustratively arranged such that alignment can only be achieved when blades 14 are in the desired alignment relative to the blades 14 of the adjoining cutter tool 12, as can be seen in FIG. 2F. The staggered helical alignment of blades 14 creates an optimal cutter assembly.

End tool 42 has only one side face 17 with either protuberances 98, recesses 100, or both. The other side face 19 of end tool 42 is illustratively substantially flat because the additional tooling of the side face 17 is not necessary. It should be understood, however, that it is not necessary to use an end tool 42, and that a plurality of cutter tools 12 could be engaged together without an end tool 42.

In another embodiment, a single cutter tool 12 could be used, without the combination of other cutter tools 12.

Illustratively, when four sets of three cutter blades 14 each are spaced about each cutter tool 12, cutter tools 12 can only align with an adjacent cutter tool 12 in one of four positions in order to accomplish the staggered helical alignment goal discussed above. However, it should be understood that the present invention is not limited to this embodiment, and other alignment methods and constructions are within the scope of the disclosure.

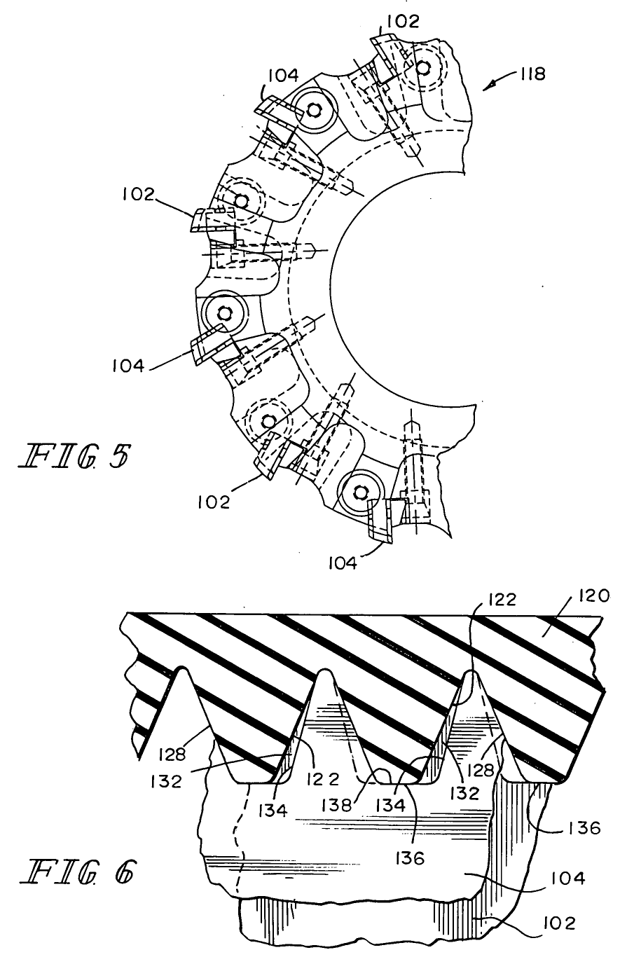

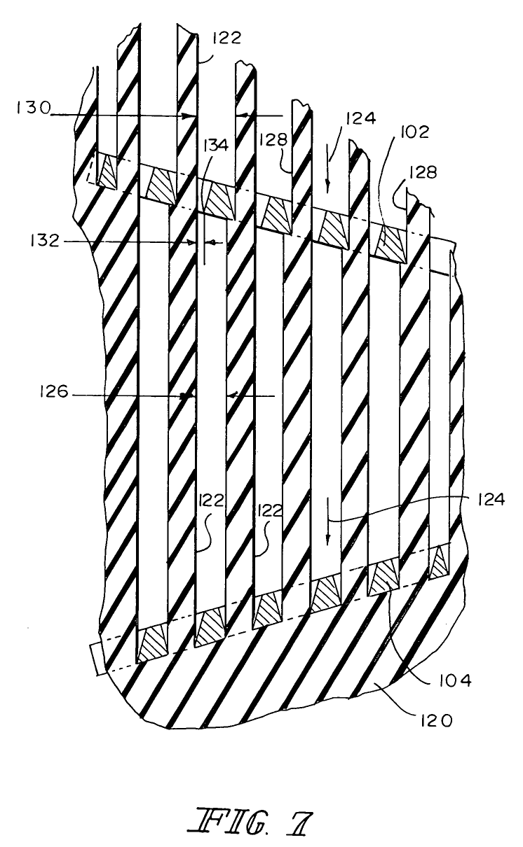

It is within the scope of the disclosure to utilize sets of two cutter blades instead of sets of three. Such an embodiment could utilize a left-hand cutter blade and a right-hand cutter blade and not utilize a raker blade. One or the other of the cutter blades, or even both cutter blades, could be configured to cut the outer diameter flat of the substrate. An illustrative set of cutter blades 102, 104 are shown in FIGS. 4A-D. Cutter blade 102 is a right-hand cutter blade shown from both the attack face 106 (FIG. 4A) and the trailing face 108 (FIG. 4B). Cutter blade 104 is a left-hand cutter blade shown from both the attack face 110 (FIG. 4C) and the trailing face 112 (FIG. 4D).

Each cutter blade 102, 104 has trailing surfaces 114, 116 (respectively) behind each tooth of the blade 102, 104. Illustratively, in the two-blade embodiment for a cutter tool, as shown in FIGS. 4-7, trailing surfaces 114, 116 are angled at approximately 45 degrees relative to trailing faces 108, 112, respectively.

Illustratively, cutter blades 102, 104 are mounted on cutter tool 118 at a positive rake angle of between 10-20 degrees, as can be seen in FIG. 5. In the illustrative configuration, six left-hand cutter blades 104 are mounted in alternating fashion with six right-hand cutter blades 102 on a single cutter tool 118. Of course, as discussed above, a plurality of cutter tools 118 can also be ganged together.

FIGS. 6 and 7 illustrate the manner in which cutter blades 102, 104 cut grooves in a substrate 120, such as rubber. Illustratively, a left-hand cutter blade 104 cuts a left groove surface 122 as it moves in the direction 124, leaving a groove of dimension 126 at the cross-sectional view shown in FIG. 7. A right-hand cutter blade 102 cuts a right groove surface 128 as it moves in the same direction 124, leaving a groove of a dimension 130 that is slightly larger than dimension 126. Illustratively, a clearance 132 exists between the trailing edge 134 of the blade and the opposing groove surface 122, as can be seen in FIGS. 6 and 7.

In the illustrative embodiment shown in FIG. 6, the outer diameter (O.D.) flat 136 of the substrate 120 is shaped and cut by raker portions 138 on blades 102, 104 (also visible in FIGS. 4A-D).

It is within the scope of the disclosure to utilize a diamond or other hard surface material embedded finishing cutter (not shown) that finish grinds any substrate surface for which a modified surface finish is desired. It will be appreciated that such finish grinding cutters could be run in combination with a plurality of the insert cutters described herein to allow for highly productive combination of the cutting and finishing processes.

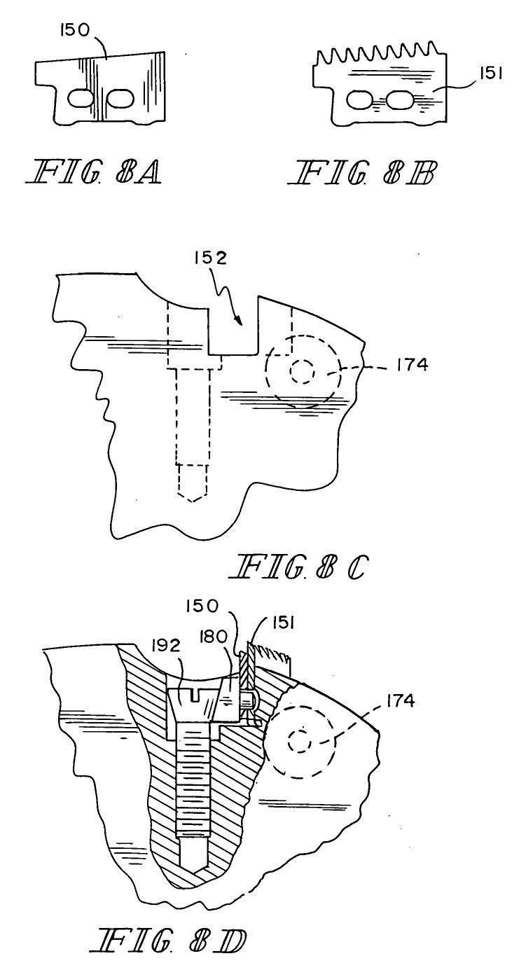

Another approach for using cutting blades (left-hand and right-hand cutting blades with teeth) with separate raker blades is shown in FIGS. 8A-8D. In this alternative combination, a raker blade 150 is associated with each cutting blade, i.e., with each left-hand cutting blade and each right-hand cutting blade, the illustrative cutting blade being indicated at 151. Both the raker blade 150 and the cutter blade 151 are provided with openings similar to the opening 76 discussed previously. The outer periphery of the rotary tool is provided with peripherally spaced apart openings as indicated at 152 in FIG. 8C. In this embodiment, as clearly illustrated, the raker blade 150 is held against the cutter blade 151 in the cavity 152 by a wedge 180 and screw 192. The wedge 180 is similar to the previously discussed wedge 80 and the screw 192 is similar to the previously discussed screw 92. It will be appreciated that the wedge lugs extending into the openings in the raker blade 150 and cutter blade 151 are somewhat longer than the lugs 78 described above. The adjustment screw 174 is similar to the screw 74 discussed previously. In the embodiment of FIGS. 8A-8D, the raker blade 150 forms the flats between the grooves which are formed by the teeth in the cutter blade 151.

1. A blade for use in cutting a grooved face of a drive belt, the blade being removably insertable into a rotary tool body having a central bore, axially spaced apart radially extending side faces, and an outer peripheral portion configured to receive and hold a plurality of blades peripherally spaced about the peripheral portion, the blade being generally flat to have a front side, a back side, a cutting edge to extend outwardly from the tool body, a base edge opposite to the cutting edge to extend into the tool body, and opposite first and second side edges between the cutting edge and base edge.

2. The blade of claim 1, wherein the blade has three spaced apart locating protuberances to engage and locate the blade on the tool body, at least one protuberance being on the base edge and at least one protuberance being on one of the side edges.

3. The blade of claim 2, wherein two protuberances are spaced apart on the base edge.

4. The blade of claim 2, wherein a notch is formed on the side edge with the protuberance.

5. The blade of claim 1, further comprising a wedge configured to engage and hold the blade against the outer peripheral portion of the tool body.

6. The blade of claim 5, wherein the blade has at least one hole formed therein and the wedge has at least one projection formed to extend into the hole.

7. The blade of claim 1, with two additional blades to provide a set of three peripherally spaced blades on the peripheral portion of the tool body and a plurality of such blade sets to be spaced about the periphery of the tool body.

8. The blades of claim 7, with the three blades of each blade set comprising a left-hand cutter blade, a right-hand cutter blade, and a raker blade, the left-hand and right-hand cutter blades each having its cutting edge formed with a plurality of spaced apart cutting teeth to form grooves in the drive belt, and the raker blade having an edge to form flats between the grooves.

9. The blades of claim 8, wherein the left-hand cutter blade and the right-hand cutter blade are mountable on the tool body such that each left-hand cutter blade and each right-hand cutter blade defines a shear angle relative to a plane which includes the axis of the tool body and extends radially outwardly from the axis.

10. The blades of claim 9, wherein the shear angle is approximately 15 degrees.

11. The blades of claim 9, wherein the shear angle is in the range of 10-20 degrees.

12. The blades of claim 9, wherein the left-hand cutter blade shear angle is opposite the right-hand cutter blade shear angle.

13. The blades of claim 8, wherein the left-hand and right-hand cutter blades are mountable on the tool body such that they each define a substantially zero-degree hook angle relative to a tool body radial plane which includes the axis of the tool body.

14. The blades of claim 8, wherein the raker blade of each set is mountable on the tool body such that it defines a hook angle relative to a tool body radial plane which includes the axis of the tool body, the hook angle being in the range of 10-30 degrees.

15. The blades of claim 14, wherein the hook angle is approximately 15 degrees.

16. The blades of claim 14, wherein each raker blade hook angle is positive such that the cutting edge of the raker blade is presented to the drive belt prior to any other surface of the raker blade.

17. The blade of claim 1, wherein the blade is positioned relative to the side edge with a positioning screw.

18. The blade of claim 17, further comprising a set screw configured to provide a backstop for the positioning screw.

19. The blade of claim 17, wherein a notch is formed in the blade, the notch being configured to receive the head of the positioning screw.

20. The blade of claim 1, with an additional blade to provide a set of two peripherally spaced blades on the peripheral portion of the tool body and a plurality of such blade sets to be spaced about the periphery of the tool body.

21. The blades of claim 20, with the two blades of each blade set comprising a left-hand cutter blade and a right-hand cutter blade, the left-hand and right-hand cutter blades each having its cutting edge formed with a plurality of spaced apart cutting teeth to form grooves in the drive belt.

22. The blades of claim 21, wherein the left-hand cutter blade and the right-hand cutter blade are mountable on the tool body such that each left-hand cutter blade and each right-hand cutter blade defines a shear angle relative to a plane which includes the axis of the tool body and extends radially outwardly from the axis.

23. A plurality of sets of drive belt grooved surface cutter blades for removable insertion into a rotary tool body having an outer peripheral portion configured to receive and hold the blades, each set of blades comprising a left-hand cutter blade and a right-hand cutter blade, the left-hand and right-hand cutter blades each having a cutting edge formed with a plurality of spaced apart cutting teeth to form grooves in a drive belt, the teeth on the left-hand blade forming the left sides of the v-grooves and the teeth on the right-hand blade forming the right sides of the v-grooves.

24. The blades of claim 23, wherein the left-hand cutter blade and the right-hand cutter blade are mountable on the tool body such that each left-hand cutter blade and right-hand cutter blade defines a shear angle relative to a tool body radial plane which includes the axis of the tool body.

25. The blades of claim 24, wherein the shear angle is in the range of 10-20 degrees.

26. The blades of claim 24, wherein the left-hand cutter blade shear angle is opposite the right-hand cutter blade shear angle.

27. The blades of claim 23, wherein the left-hand and right-hand cutter blades are mounted on the tool body such that they each define a substantially zero-degree hook angle relative to a tool body radial plane which includes the axis of the tool body.

28. The blades of claim 23, wherein each of the teeth on the left-hand blades and right-hand blades is configured to form a side of the v-groove and at least a portion of the belt O.D. flat between that groove side and the next adjacent groove.

29. The blades of claim 23, wherein each of the blade teeth is formed to cut the entire O.D. flat between that groove side and the adjacent groove.

30. The blades of claim 23, comprising a raker blade for each set of blades to be mounted on the tool body to define a hook angle relative to a tool body radial plane which includes the axis of the tool body, the hook angle being in the range of 10-30 degrees, the raker blade of each set of blades forming the belt O.D. flats between the grooves.

31. The blades of claim 30, wherein each raker blade hook angle is positive such that the cutting edge of the raker blade is presented to the drive belt prior to any other surface of the raker blade.

32. The blades of claim 23, wherein each blade has at least one aperture formed therein for receiving a blade-retaining projections.

33. The blades of claim 23, wherein each blade is formed to include three spaced apart locating protuberances.

34. The blades of claim 33, wherein each blade has a cutting edge, a base edge, and two side edges, the base edge having two locating protuberances and one of the side edges having the third locating protuberance.

35. The blades of claim 34, wherein one of the side edges is formed to define a notch, the notch being configured to receive a positioning screw.

36. The blades of claim 23, wherein each blade has at least one aperture formed therein and comprising, for each blade, a blade-retaining wedge having at least one protrusion for mating with the at least one aperture.

37. The blades of claim 23, wherein each blade is generally flat and has a front side and a back side, the cutting edge of each blade being formed to have a trailing surface that is at an angle relative to the front side.

38. The blades of claim 37, wherein the angle is approximately 40 degrees.

39. A plurality of cutting tools to be ganged together on a common arbor defining an axis and a plurality of cutter blades removably coupled to each tool, each tool comprising a tool body having a central bore for receiving the arbor, radially extending side faces abutting side faces of adjacent tool bodies when they are on the arbor, and an outer peripheral portion to which the cutter blades are removably coupled, the cutter blades being arranged in sets of blades with a plurality of blade sets peripherally spaced about each tool body, each tool body having for each set of blades coupled thereto at least one recess in one side face and at least one protuberance extending axially from at least one side face, the protuberances on the tool bodies engaging into recesses on adjacent tool bodies when the tools are ganged on the arbor.

40. The cutting tools of claim 39, comprising for each blade a positioning screw to position the blade relative to the cutting tool to which it is coupled.

41. The cutting tools of claim 40, wherein the positioning screw mates with a screw hole formed in a side face of the cutting tool.

42. The cutting tools of claim 41, wherein the screw hole is formed in a non-recessed side face portion.

43. The cutting tools of claim 39, further comprising an end tool, the end tool having a plurality of end cutter blades removably coupled thereto.

44. In combination, a plurality of cutting tool bodies to be ganged together on a common arbor defining an axis with the cutter blades of claim 23 removably coupled to each tool body, each tool body having a central bore for receiving the arbor and radially extending side faces abutting side faces of adjacent tool bodies when they are on the arbor, the cutter blades being arranged in sets of blades with a plurality of blade sets peripherally spaced about each tool body, each tool body having at least one recess in one side face and at least one protuberance extending axially from at least one side face, the protuberances on the tool bodies engaging into recesses on adjacent tool bodies when the tools are ganged on the arbor.

45. The cutting tools of claim 44, wherein the end cutter blades define a width that is greater than a width defined by the cutter blades of the tools.

46. The cutting tools of claim 44, wherein the end cutter blades are configured to carve two cut grooves in a drive belt surface.

47. The blades of claim 23 wherein each of the left-hand cutter blades has a side edge and its plurality of spaced apart cutting teeth each has a right side viewed from the back of the blade having a tapered beveled surfaces relative to the side edge of the blade and wherein each of the right-hand cutter blades has a side edge and its plurality of spaced apart cutting teeth each has a left side viewed from the back of the blade having a tapered beveled surface relative to the side edge of the blade.

48. The blades of claim 47 in which the tapered bevel surfaces are approximately 30 degrees relative to the side edge of the blade.

49. The blades of claim 8 wherein each of the left-hand cutter blades is found with its plurality of cutting teeth each having a right side viewed from the back of the blade which is beveled and wherein each of the right-hand cutter blades is formed with each of its plurality of cutting teeth each having a left side viewed from the back of the blade which is beveled.

50. The blades of claim 49 wherein the right side of each cutting tooth on the left-hand cutter blade is beveled at approximately 30 degrees and wherein the left side of each cutting tooth on the right-hand cutter blade is beveled at approximately 30 degrees.

51. The blade of claim 1 wherein the cutting edge is formed with a plurality of teeth to cut side edges of grooves in a drive belt, and in combination with the blade, a raker blade to be inserted into the rotary tool body against the blade formed with the plurality of teeth, the raker blade forming flats between the grooves.

52. The blades of claim 51 comprising a wedge to engage and hold the blade with teeth and the associated raker blade against the other peripheral portion of the tool body.

53. The blades of claim 23 comprising, for each left-hand cutter blade and each right-hand cutter blade, a raker blade to be inserted into the outer peripheral portion of the rotary tool against its associated cutter blade, the raker blades to form the flats between the grooves.

54. The blades of claims 53 comprising a wedge to hold each raker blade against its associated cutter blade in the rotary tool.
